(19) United States
(12) Patent Application Publication
(10) Pub. No.: US 2020/0219503 A1
(43) Pub. Date: Jul. 9, 2020

(54) METHOD AND APPARATUS FOR FILTERING OUT VOICE INSTRUCTION

(71) Applicant: Baidu Online Network Technology (Beijing) Co., Ltd., Beijing (CN)

(72) Inventors: Liang HE, Beijing (CN); Aihui AN, Beijing (CN); Yu NIU, Beijing (CN); Lifeng ZHAO, Beijing (CN); Xiangdong XUE, Beijing (CN); Ji ZHOU, Beijing (CN)

(73) Assignee: Baidu Online Network Technology (Beijing) Co., Ltd., Beijing (CN)

(21) Appl. No.: 16/698,627

(22) Filed: Nov. 27, 2019

(30) Foreign Application Priority Data
Jan. 3, 2019 (CN) 201910004960.8

(51) Int. Cl. G10L 15/22; G10L 15/18

(52) U.S. Cl. CPC G10L 15/22; G10L 2015/088; G10L 15/1815

(57) ABSTRACT

A method and apparatus for filtering out a voice instruction are provided. The method includes: receiving a conversation voice in a conversation process; determining whether control instruction information is included in the conversation voice; and filtering out the conversation voice with the control instruction information and prohibiting from sending the conversation voice to the opposite equipment of the conversation process. The apparatus includes a receiving module configured to receive a conversation voice in a conversation process, a determination module configured to determine whether control instruction information is included in the conversation voice, and a conversation module configured to filter out the conversation voice and prohibit from sending the conversation voice to an opposite equipment of the conversation process, in response to a determination of control instruction information in the conversation voice.

### CROSS-REFERENCE TO RELATED APPLICATION

This application claims priority to Chinese patent application No. 201910004960.8, filed on Jan. 3, 2019, which is hereby incorporated by reference in its entirety.

### TECHNICAL FIELD

The present application relates to a field of voice interaction technology, and in particular, to a method and apparatus for filtering out a voice instruction.

### BACKGROUND

With the rapid development of a smart screen device, a voice wake-up and voice identification technology is increasingly used to initiate and support an audio or video conversation. For example, instead of a conventional manual operation on a touch screen, a smart screen device may be woken up by a voice and may perform operations according to a voice query control instruction. In this way, an audio or video conversation may be initiated more intelligently and conveniently. However, in a conversation process, a user may issue a voice query control instruction to invoke his device to perform an operation. In this case, the voice query control instruction may be heard or received by another user at an opposite equipment of the conversation process, thereby reducing conversation quality and resulting in a poor user experience.

The above information disclosed in the Background is merely for enhancing understanding of the background of the present application, so it may contain information that does not form the existing technology known to those ordinary skilled in the art.

### SUMMARY

A method and apparatus for filtering out a voice instruction are provided according to embodiments of the present application, so as to at least solve the above one or more technical problems in the existing technology.

In a first aspect, a method for filtering out a voice instruction is provided according to an embodiment of the present application. The method includes: receiving a conversation voice in a conversation process; determining whether control instruction information is included in the conversation voice; and filtering out the conversation voice with the control instruction information and prohibiting from sending the conversation voice to an opposite equipment of the conversation process, in response to a determination of control instruction information in the conversation voice.

In an implementation, the method further includes sending the conversation voice to the opposite equipment of the conversation process, in response to a determination of no control instruction information in the conversation voice.

In an implementation, the determining whether control instruction information is included in the conversation voice includes: identifying a preset wake-up word in the conversation voice; and performing a semantic analysis on the conversation voice with the wake-up word and determining whether control instruction information carrying an operational intention is included in content of the conversation voice.

In an implementation, the determining whether control instruction information is included in the conversation voice includes: performing a semantic analysis on the conversation voice; determining target intention of content of the conversation voice; matching the target intention with preset operational intention; and determining whether the control instruction information is included in the conversation voice according to a result of the matching.

In an implementation, after filtering out the conversation voice with the control instruction information and prohibiting from sending the conversation voice to an opposite equipment of the conversation process, in response to a determination of control instruction information in the conversation voice, the method further includes performing an operation associated with the control instruction information, according to the control instruction information.

In a second aspect, an apparatus for filtering out a voice instruction is provided according to an embodiment of the present application. The apparatus includes a receiving module configured to receive a conversation voice in a conversation process, a determination module configured to determine whether control instruction information is included in the conversation voice, and a conversation module configured to prohibit from sending the conversation voice to an opposite equipment of the conversation process, in response to a determination of control instruction information in the conversation voice.

In an implementation, the conversation module is further configured to send the conversation voice to the opposite equipment of the conversation process, in response to a determination of no control instruction information in the conversation voice.

In an implementation, the conversation module is further configured to receive the conversation voice from the determination module and send the conversation voice to the opposite equipment of the conversation process, or receive the conversation voice from the receiving module and send the conversation voice to the opposite equipment of the conversation process.

In an implementation, the determination module is further configured to filter out the conversation voice or notify the conversation module to filter out the conversation voice received from the receiving module.

In a third aspect, a terminal for filtering out a voice instruction is provided according to an embodiment of the present application. The functions may be implemented by using hardware or by corresponding software executed by hardware. The hardware or software includes one or more modules corresponding to the above functions.

In a possible embodiment, the terminal for filtering out a voice instruction structurally includes a processor and a memory, wherein the memory is configured to store programs which support the terminal for filtering out a voice instruction in executing the method for filtering out a voice instruction in the first aspect. The processor is configured to execute the programs stored in the memory. The terminal for filtering out a voice instruction may also include a communication interface through which the terminal for filtering out a voice instruction communicates with other devices or communication networks.

In a fourth aspect, a computer readable storage medium for storing computer software instructions used for a terminal for filtering out a voice instruction is provided. The computer readable storage medium may include programs involved in executing the method for filtering out a voice instruction described above in the first aspect.

One of the above technical solutions has the following advantages or beneficial effects: in embodiments of the present application, by identifying and filtering out a conversation voice with control instruction information, voice instructions in a conversation may be prohibited from being sent to an opposite equipment of the conversation process, thereby avoiding an interference to the conversation and improving conversation quality.

The above summary is provided only for illustration and is not intended to be limiting in any way. In addition to the illustrative aspects, embodiments, and features described above, further aspects, embodiments, and features of the present application will be readily understood from the following detailed description with reference to the accompanying drawings.

### BRIEF DESCRIPTION OF THE DRAWINGS

In the drawings, unless otherwise specified, identical or similar parts or elements are denoted by identical reference numerals throughout the drawings. The drawings are not necessarily drawn to scale. It should be understood these drawings merely illustrate some embodiments of the present application and should not be construed as limiting the scope of the present application.

FIG. 1 is a flowchart showing a method for filtering out a voice instruction according to an embodiment of the present application;

FIG. 2 is a flowchart showing a method for filtering out a voice instruction according to another embodiment of the present application;

FIG. 3 is a flowchart showing S200 of a method for filtering out a voice instruction according to an embodiment of the present application;

FIG. 4 is a flowchart showing S200 of a method for filtering out a voice instruction according to another embodiment of the present application;

FIG. 5 is a flowchart showing a method for filtering out a voice instruction according to yet another embodiment of the present application;

FIG. 6 is a schematic structural diagram showing an apparatus for filtering out a voice instruction according to an embodiment of the present application;

FIG. 7 is a flow block diagram showing a first application example according to an embodiment of the present application;

FIG. 8 is a flow block diagram showing a second application example according to an embodiment of the present application; and

FIG. 9 is a schematic structural diagram showing a terminal for filtering out a voice instruction according to an embodiment of the present application.

### DETAILED DESCRIPTION OF THE EMBODIMENTS

Hereafter, only certain exemplary embodiments are briefly described. As can be appreciated by those skilled in the art, the described embodiments may be modified in different ways, without departing from the spirit or scope of the present application. Accordingly, the drawings and the description should be considered as illustrative in nature instead of being restrictive.

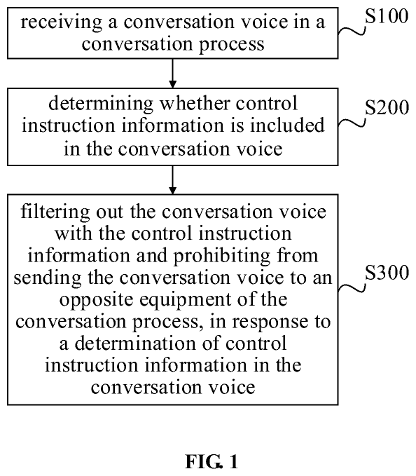

As shown in FIG. 1, a method for filtering out a voice instruction is provided.

The method may include receiving, at a computing device such as a mobile phone, a conversation voice in a conversation process at S100. In a conversation process, for example, at least two users may make a video call, or an audio call. A conversation voice may include a voice, which is sent from a user and received by a microphone of a terminal device such as a mobile phone, in a conversation process.

The method may further include determining whether control instruction information is included in the conversation voice at S200. Control instruction information may be understood as operation information that a user instructs a terminal device to operate. Typically, such control instruction information is not intended to be heard or received by another user at an opposite equipment of a conversation process.

In an example, a conversation voice may be identified directly, and then it may be determined whether control instruction information is included in the conversation voice. In another example, a conversation voice may be converted into conversation data first, and the converted conversation data may be identified, then it may be determined whether control instruction information is included in the converted conversation data. Specific mode for identifying control instruction information may be selected according to device functions or user requirements. For example, when it is necessary to encrypt a conversation in order to prevent the conversation from being monitored, the mode of identifying converted conversation data associated with a conversation voice may be selected, so as to determine whether control instruction information is included in the converted conversation data, and thus to determine whether control instruction information is included in the conversation voice, thereby improving the safety of a conversation between users.

The method may further include filtering out the conversation voice with the control instruction information and prohibiting from sending the conversation voice to the opposite equipment of the conversation process, in response to a determination of control instruction information in the conversation voice at S300. That is to say, in a conversation process, a conversation voice with control instruction information is filtered out and prohibited from being sent to an opposite equipment, so that the conversation voice with the control instruction information may not be received or heard by other users at the opposite equipment.

In an implementation, the determination whether control instruction information is included in the conversation voice includes identifying the conversation voice by using a preset identification algorithm, to determine whether voice information matching preset control instruction information is included in the conversation voice. In a case where voice information matching preset control instruction information is included in the conversation voice, the voice information is determined to be control instruction information.

In another implementation, the determination whether control instruction information is included in the conversation voice includes performing voice analysis and conversion on the conversation voice, to obtain conversation data, and identifying the conversation data by using a preset identification algorithm, to determine whether data matching preset control instruction information is included in the conversation data. In a case where data matching preset control instruction information is included in the conversation voice, the data is determined to be control instruction information.

For example, by using voice identification technology, a conversation voice may be converted into conversation data with a text format. The conversation data with a text format may be identified, so that it may be determined whether data matching preset control instruction information is included in the conversation data with a text format. The preset control instruction information may include a variety of information, such as “turn down the volume”, “turn up the volume”, or “close the application”. Then, based on the determined data matching the preset control instruction information in the conversation data with a text format, it may be determined that control instruction information is included in the conversation voice.

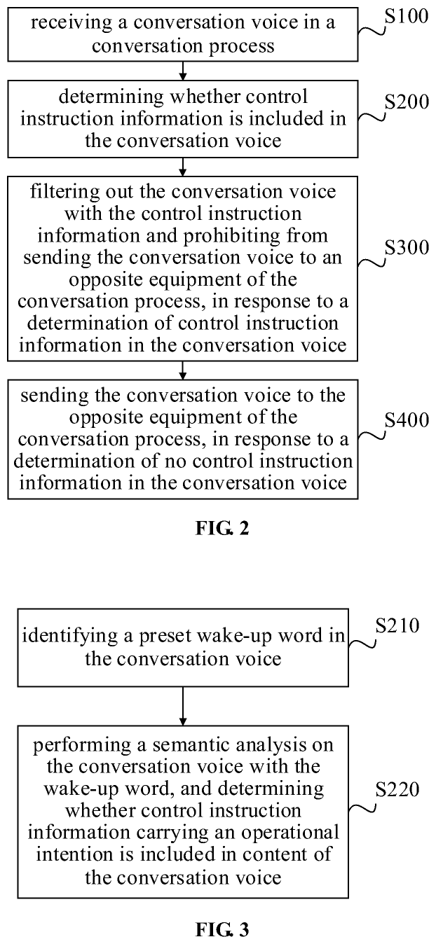

As shown in FIG. 2, in an implementation, the method further includes sending the conversation voice to the opposite equipment of the conversation process, in response to a determination of no control instruction information in the conversation voice at S400. That is to say, in a conversation process, a conversation voice without control instruction information is send to opposite equipment, so that the conversation voice without the control instruction information may be heard by other users at the opposite equipment of the conversation process.

As shown in FIG. 3, in an implementation, the determining whether control instruction information is included in the conversation voice includes identifying a preset wake-up word in the conversation voice at S210. A wake-up word may be understood as a word which can invoke a terminal equipment of a user to perform an operation according to the control instruction information issued by the user.

The determining whether control instruction information is included in the conversation voice may further include performing a semantic analysis on the conversation voice with the wake-up word and determining whether control instruction information carrying an operational intention is included in content of the conversation voice at S220.

After a wake-up word in a conversation voice is identified, in order to avoid erroneously determining a conversation voice with the wake-up word as a conversation voice which contains control instruction information carrying an operational intention, a semantic analysis may be performed on the conversation voice with the wake-up word. Further, a semantic analysis may also be performed on at least one subsequent conversation voice following the conversation voice with the wake-up word, in order to more accurately determine whether control instruction information carrying an operational intention is included in content of a conversation voice. In this way, a conversation voice with a wake-up word, which does not contain operational intention however, may not be erroneously filtered out, thereby ensuring that a user at an opposite equipment may hear all the conversation content containing no control instruction information. For example, a preset wake-up word for a user's terminal device may be “Xiao Du”. A conversation voice spoken out by a user may be “do you know where our high school classmate, Xiao Du, is working now?” In this example, the wake-up word “Xiao Du” is included in the conversation voice. However, after a semantic analysis on the conversation voice with the wake-up word is performed, it can be determined that no operational intention is contained in the content of the conversation voice. That is to say, when speaking out the conversation voice, the user does not intent to invoke his terminal device to perform any operation.

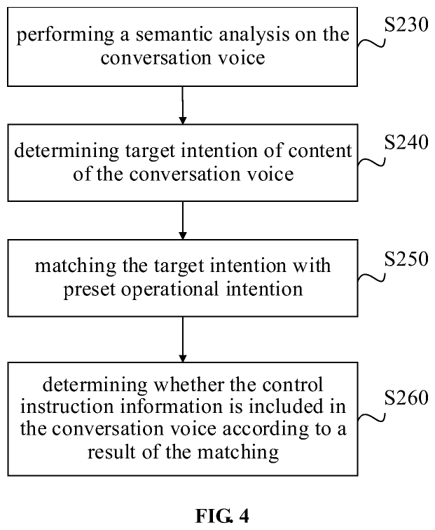

As shown in FIG. 4, in an implementation, the determining whether control instruction information is included in the conversation voice includes performing a semantic analysis on the conversation voice at S230 and determining target intention of content of the conversation voice at S240. A target intention may be understood as an intention contained in a conversation voice spoken out by a user. For example, a conversation voice of a user may be “where are you going tomorrow afternoon?” After a semantic analysis is performed on the conversation voice, it may be determined that the target intention of the conversation voice is to ask another person's schedule for tomorrow.

For another example, a conversation voice of a user may be “please help me turn down the volume”. After a semantic analysis is performed on the conversation voice, it may be determined that the target intention of the conversation voice is to adjust the volume of a terminal device.

In an implementation, the determining whether control instruction information is included in the conversation voice may further include matching the target intention with preset operational intention at S250 and determining whether the control instruction information is included in the conversation voice according to a result of the matching at S260. Preset operational intention may be understood as intention of control instruction information included in a preset voice instruction, which may invoke a terminal equipment of a user to perform an operation. For example, preset operational intention may be intention included in a voice instruction such as “hang up the phone”, “turn up the volume”, or “switch to a mode (mute, hands-free or headset mode)”.

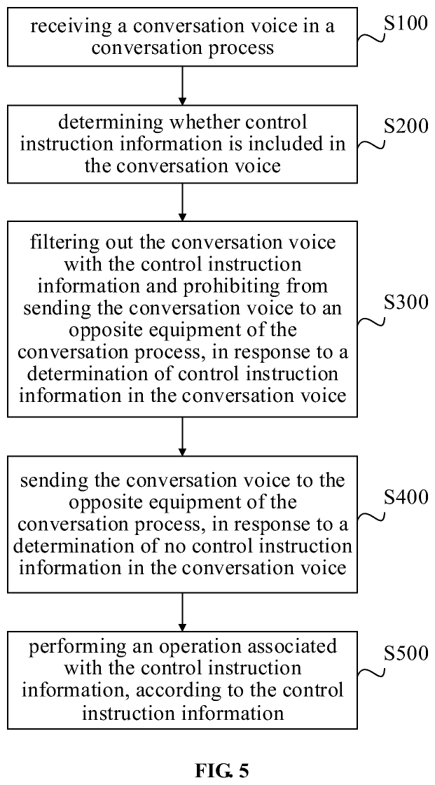

As shown in FIG. 5, in an implementation, after filtering out the conversation voice with the control instruction information and prohibiting from sending the conversation voice to an opposite equipment of the conversation process, in response to a determination of control instruction information in the conversation voice, the method further includes performing an operation associated with the control instruction information, according to the control instruction information at S500.

In an implementation, a pause interval made by a user in a conversation process may be identified. A word segmentation may be performed on a conversation voice of a user based on the pause interval, to obtain at least one word. Compared with a long conversation voice, it is much easier to identify or perform a semantic analysis on a single word or some short words. In this way, it is possible to more accurately determine whether control instruction information is included in content of a conversation voice of a user.

It should be noted that the method according to the foregoing embodiment may be applied to any type of smart devices, as long as the device may be used to initiate a conversation.

An apparatus for filtering out a voice instruction is provided according to an embodiment of the present application. As shown in FIG. 6, the apparatus includes: a receiving module 10 configured to receive a conversation voice in a conversation process, an identification module 20 configured to determine whether control instruction information is included in the conversation voice, and a conversation module 30 configured to prohibit from sending the conversation voice to an opposite equipment of the conversation process, in response to a determination of control instruction information in the conversation voice.

In an implementation, the conversation module 30 is further configured to send the conversation voice to the opposite equipment of the conversation process, in response to a determination of no control instruction information in the conversation voice.

In an implementation, the conversation module 30 is further configured to receive the conversation voice from the identification module, and send the conversation voice to the opposite equipment of the conversation process, or receive the conversation voice from the receiving module, and send the conversation voice to the opposite equipment of the conversation process.

In an implementation, the identification module 20 is further configured to filter out the conversation voice or notify the conversation module 30 to filter out the conversation voice received from the receiving module 10.

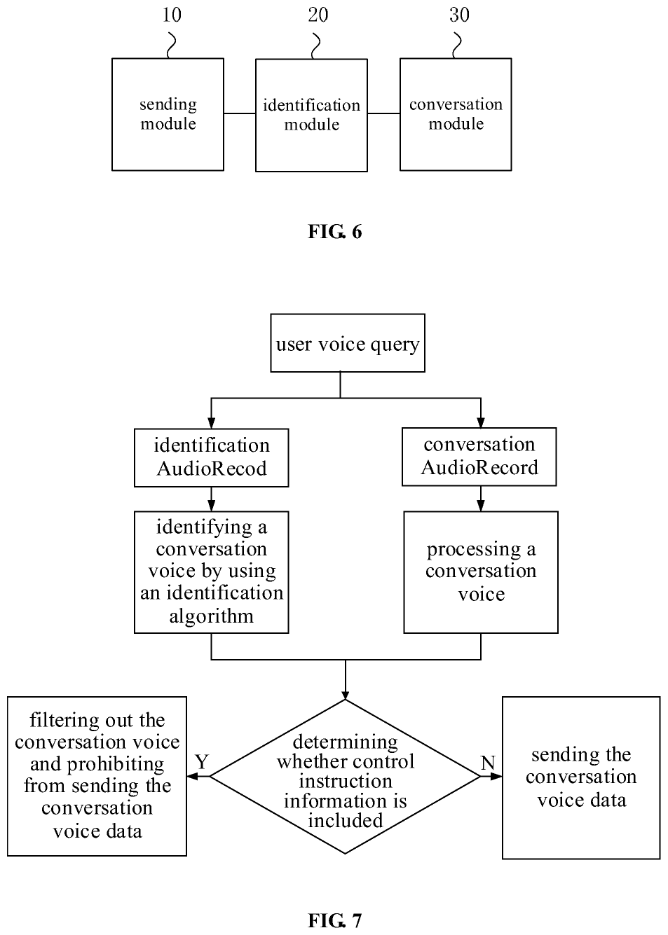

As shown in FIG. 7, in a first application example, a filtering apparatus equipped with a DuerOS conversational artificial intelligence system includes two AudioRecord modules. The two

AudioRecord modules perform operations independently. The identification AudioRecord module (i.e., the identification module 20) is configured to identify control instruction information included in a conversation voice, and the conversation AudioRecord module (i.e., the conversation module 30) is configured to perform conventional processing on a conversation voice. Specifically, the conversation AudioRecord module receives a user voice Query (a conversation voice) from a receiving module 10 and performs conventional voice processing on the conversation voice. For example, the conversation AudioRecord module may perform conventional voice processing such as adjusting audio quality or performing noise reduction processing, so as to ensure voice quality. Then, the conversation AudioRecord module may temporarily store the processed conversation voice. That is to say, the processed conversation voice may not be sent to an opposite equipment temporarily. The identification AudioRecord module also receives the user voice Query (a conversation voice) from the receiving module 10 and identifies the conversation voice by using a preset identification algorithm. If it is determined that control instruction information is included in the conversation voice, the identification AudioRecord module sends a filtering instruction to the conversation AudioRecord module, and also sends the control instruction information to an associated execution module for processing. After receiving the filtering instruction, the conversation AudioRecord module filters out the conversation voice with the control instruction information and prohibit from sending the conversation voice to an opposite equipment of the conversation process. In this way, it may be assured that a user at the opposite equipment does not receive a conversation voice containing control instruction information. If it is determined that no control instruction information is included in the conversation voice, the identification AudioRecord module sends a sending instruction to the conversation AudioRecord module. Then, after receiving the sending instruction, the conversation AudioRecord module sends the conversation voice to the opposite equipment of the conversation process, thereby ensuring the conversation integrity.

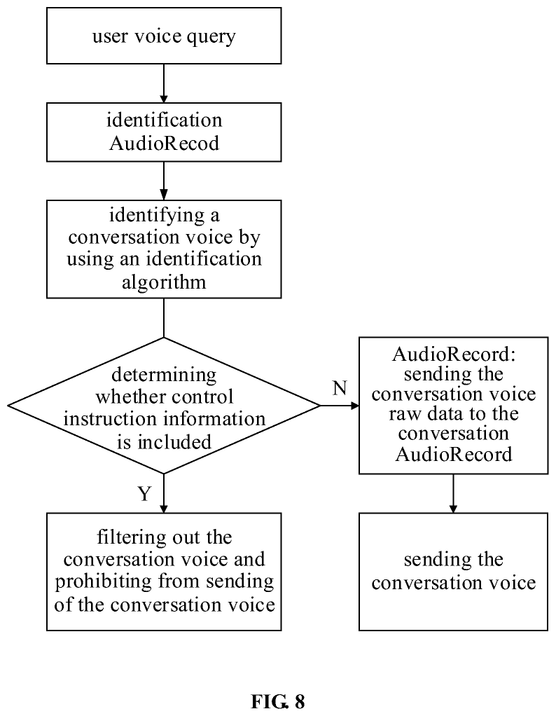

As shown in FIG. 8, in a second application example, a filtering apparatus equipped with a DuerOS conversational artificial intelligence system includes two AudioRecord modules. The two AudioRecord modules perform operations cooperatively. The identification AudioRecord module (i.e., the identification module 20) is configured to identify control instruction information included in a conversation voice, and the conversation AudioRecord module (i.e., the conversation module 30) is configured to perform conventional processing on a conversation voice. Specifically, the identification AudioRecord module receives a user voice Query (a conversation voice) from a receiving module 10 and identifies the conversation voice by using a preset identification algorithm. If it is determined that control instruction information is included in the conversation voice, the identification AudioRecord module filters out the conversation voice with the control instruction information and prohibit from sending the conversation voice to the conversation AudioRecord module. Then, the identification AudioRecord module sends the control instruction information to an associated execution module for processing. If it is determined that no control instruction information is included in the conversation voice, the identification AudioRecord module sends conversation voice raw data to the conversation AudioRecord module. After receiving the conversation voice raw data, the conversation AudioRecord module performs conventional voice processing on the conversation voice raw data, to obtain a processed conversation voice, and then sends the processed conversation voice to a user at the opposite equipment.

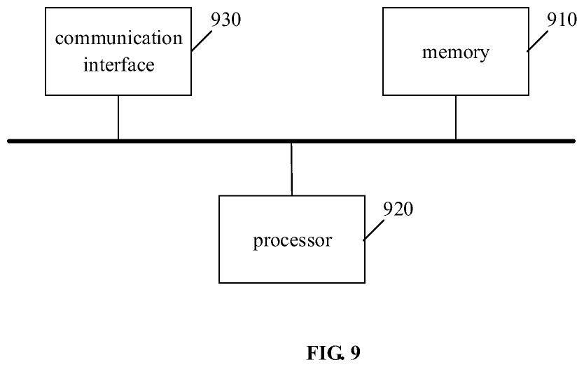

As shown in FIG. 9, a terminal for filtering out a voice instruction is provided according to an embodiment of the present application. The terminal includes a memory 910 and a processor 920, wherein a computer program that can run on the processor 920 is stored in the memory 910. The processor 920 executes the computer program to implement the method for filtering out a voice instruction in the above embodiment. The number of either the memory 910 or the processor 920 may be one or more.

The terminal may further include a communication interface 930 configured to enable the memory 910 and processor 920 to communicate with an external device and exchange data.

The memory 910 may include a high-speed RAM memory and may also include a non-volatile memory, such as at least one magnetic disk memory.

If the memory 910, the processor 920, and the communication interface 930 are implemented independently, the memory 910, the processor 920, and the communication interface 930 can be connected to each other via a bus to realize mutual communication. The bus may be an Industrial Standard Architecture (ISA) bus, a Peripheral Component Interconnect (PCI) bus, an Extended Industry Standard Component (EISA) bus, or he like. The bus may be categorized into an address bus, a data bus, a control bus, and the like. For ease of illustration, only one bold line is shown in FIG. 9 to represent the bus, but it does not necessarily mean that there is only one bus or one type of bus.

Optionally, in a specific implementation, if the memory 910, the processor 920, and the communication interface 930 are integrated on one chip, the memory 910, the processor 920, and the communication interface 930 may implement mutual communication through an internal interface.

In an embodiment of the present invention, it is provided a computer-readable storage medium having computer programs stored thereon. When executed by a processor, the programs implement the method for filtering out a voice instruction according to the foregoing embodiment.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. The computer readable medium of the embodiments of the present application may be a computer readable signal medium or a computer readable storage medium or any combination of the above. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A method for filtering out a voice instruction, comprising:
receiving a conversation voice in a conversation process;
determining whether control instruction information is comprised in the conversation voice; and
filtering out the conversation voice with the control instruction information and prohibiting from sending the conversation voice to an opposite equipment of the conversation process, in response to a determination of control instruction information in the conversation voice.

2. The method for filtering out a voice instruction according to claim 1, further comprising:
sending the conversation voice to the opposite equipment of the conversation process, in response to a determination of no control instruction information in the conversation voice.

3. The method for filtering out a voice instruction according to claim 1, wherein the determining whether control instruction information is comprised in the conversation voice comprises:
identifying a preset wake-up word in the conversation voice; and
performing a semantic analysis on the conversation voice with the wake-up word and determining whether control instruction information carrying an operational intention is comprised in content of the conversation voice.

4. The method for filtering out a voice instruction according to claim 1, wherein the determining whether control instruction information is comprised in the conversation voice comprises:
performing a semantic analysis on the conversation voice;
determining a target intention of content of the conversation voice;
matching the target intention with a preset operational intention; and
determining whether the control instruction information is comprised in the conversation voice according to a result of the matching.

5. The method for filtering out a voice instruction according to claim 1, wherein after filtering out the conversation voice with the control instruction information and prohibiting from sending the conversation voice to an opposite equipment of the conversation process, in response to a determination of control instruction information in the conversation voice, the method further comprises:
performing an operation associated with the control instruction information, according to the control instruction information.

6. An apparatus for filtering out a voice instruction, comprising:
one or more processors; and
a non-transitory memory for storing computer executable instructions, wherein
the computer executable instructions are executed by the one or more processors to enable the one or more processors to:
receive a conversation voice in a conversation process;
determine whether control instruction information is comprised in the conversation voice; and
prohibit from sending the conversation voice to an opposite equipment of the conversation process, in response to a determination of control instruction information in the conversation voice.

7. The apparatus for filtering out a voice instruction according to claim 6, wherein the computer executable instructions are executed by the one or more processors to enable the one or more processors to send the conversation voice to the opposite equipment of the conversation process, in response to a determination of no control instruction information in the conversation voice.

8. The apparatus for filtering out a voice instruction according to claim 7, wherein the computer executable instructions are executed by the one or more processors to enable the one or more processors to:
receive the conversation voice from the identification module and send the conversation voice to the opposite equipment of the conversation process; or
receive the conversation voice from the receiving module and send the conversation voice to the opposite equipment of the conversation process.

9. The apparatus for filtering out a voice instruction according to claim 6, wherein the one or more programs are executed by the one or more processors to enable the one or more processors to:
filter out the conversation voice; or
notify the conversation module to filter out the conversation voice received from the receiving module.

10. A non-transitory computer-readable storage medium, having computer executable instructions stored thereon, that when executed by a processor, causes the processor to:
receive a conversation voice in a conversation process;
determine whether control instruction information is comprised in the conversation voice; and
filter out the conversation voice with the control instruction information and prohibiting, in response to a determination of control instruction information in the conversation voice, from sending the conversation voice to an opposite equipment of the conversation process.
